(19) United States
(12) Patent Application Publication
(10) Pub. No.: US 2021/0001236 A1
(43) Pub. Date: Jan. 7, 2021

(54) SYSTEM AND METHOD FOR INTEGRATING LIVE VIDEO COMMUNICATION AND CONTENT IN THE CONTEXT OF INTERNET-BASED SPORTS GAMING MOBILE DEVICE APPLICATION

(71) Applicant: SCORETRADE INC., Greenbrae, CA (US)

(72) Inventor: Bhuvanesh Srinivasan, Greenbrae, CA (US)

(21) Appl. No.: 16/920,404

(22) Filed: Jul. 2, 2020

Related U.S. Application Data
(60) Provisional application No. 62/870,474, filed on Jul. 3, 2019.
(60) Provisional application No. 62/928,955, filed on Oct. 31, 2019.

(51) Int. Cl. A63F 13/86; A63F 13/87

(52) U.S. Cl. CPC A63F 13/86; A63F 13/87

(57) ABSTRACT

In a system for system for operating a sports gaming event using a graphical interface of a mobile device application, the system includes: a processor; and a memory coupled to the processor, wherein the memory stores instructions that, when executed by the processor, cause the processor to: initiate a live video stream from a host user; send an invite to view the live video stream to a user; receive a response to the invite from the user; generate a betting scenario from the live video stream; send the betting scenario to the user; receive a response to the betting scenario from the user; and update the live video stream based on the response from the user.

### CROSS-REFERENCE TO RELATED APPLICATION(S)

This application claims priority to and the benefit of U.S. Provisional Patent Application No. 62/870,474 filed Jul. 3, 2019 and entitled “SYSTEM OF IN-APP INTEGRATION OF LIVE VIDEO CONTENT IN THE CONTEXT OF INTERNET-BASED WAGERING MOBILE APPLICATIONS”, the entire content of which is incorporated herein by reference. This application further claims priority to and the benefit of U.S. Provisional Patent Application No. 62/928,955 filed Oct. 31, 2019 and entitled “A SYSTEM OF INTEGRATING AUTHENTICATED PAY TELEVISION STREAMS INTO MOBILE IN-GAME SPORTS GAMING APPLICATIONS”, the entire content of which is incorporated herein by reference.

### FIELD

One or more aspects of embodiments according to the present disclosure relate to systems and methods for integrating live video content in the context of internet-based sports gaming mobile device application.

### BACKGROUND

Online gaming has increased in popularity, especially after the Supreme Court of the United States ruling that individual states could legalize sports gambling within their states. Online gaming players (e.g., users) can engage in online sports gaming through mobile device applications. Using the applications, players can place bets on the final outcome of sporting events or on a specific event occurring within the sporting event (e.g., a proposition bet or a prop bet). In addition, bets or selections can be made in the context of fantasy sports, where the user is attempting to select a roster or portfolio of player prop bets and bets. For example, a player can place a bet on whether a basketball player will have 20 points by halftime. Players can submit bets using real money or with fake money generated within the mobile device application. Mobile device applications can allow players to participate in gaming tournaments with a large number of players or in smaller groups with a select number of friends. Players may consider a number of different factors when deciding to place a bet on sporting events, such as the health of individual players or weather. However, sports gaming applications generally do not allow players to view other players' gaming portfolios. This information can be helpful for players to consider when placing their bets.

The above information disclosed in this Background section is only for enhancement of understanding of the background of the present disclosure, and therefore, it may contain information that does not form prior art.

### SUMMARY

Aspects of embodiments of the present disclosure are directed toward systems and methods for integrating live video content in the context of internet-based sports gaming mobile device application.

According to some example embodiments of the present disclosure, in a system for operating a sports gaming event using a graphical interface of a mobile device application, the system including: a processor; and a memory coupled to the processor, wherein the memory stores instructions that, when executed by the processor, cause the processor to: initiate a live video stream from a host user; send an invite to view the live video stream to a user; receive a response to the invite from the user; generate a betting scenario from the live video stream; send the betting scenario to the user; receive a response to the betting scenario from the user; and update the live video stream based on the response from the user.

According to some example embodiments, the instructions further cause the processor to: invite an additional user to view the live video stream; receive an additional live video stream from the additional user; display the additional live video stream on the interface of the mobile device application; send the betting scenario to the additional user; receive an additional response to the betting scenario from the additional user; and update the live video stream based on the additional response to the betting scenario.

According to some example embodiments, the instructions further cause the processor to display a graphic on the additional live video stream, wherein the graphic is based on the additional response to the betting scenario.

According to some example embodiments, the instructions further cause the processor to display a ticker on the additional live video scream, wherein the ticker displays the additional response to the betting scenario.

According to some example embodiments, the betting scenario is generated by the host user.

According to some example embodiments, the instructions further cause the processor to: retrieve a previous response to a previous betting scenario by the user; generate a new betting scenario based on the previous response; and send the new betting scenario to the user.

According to some example embodiments, the instructions further cause the processor to display a leaderboard.

According to some example embodiments, the instructions further cause the processor to display a list of previous responses to previous betting scenarios by the user.

According to some example, embodiments, the instructions further cause the processor to: initiate a gaming tournament; invite the user to participate in the gaming tournament; generate a plurality of betting scenarios for the gaming tournament; send the plurality of betting scenarios to the user; and receive responses to the plurality of betting scenarios from the user.

According to some example embodiments of the present disclosure, in a system for participating in a sports gaming event using a graphical interface of a mobile device application, the system includes: a processor; and a memory coupled to the processor, wherein the memory stores instructions that, when executed by the processor, cause the processor to: display a live video stream; receive a betting scenario generated from the live video stream; display the betting scenario on a bet selection interface; and receive a response from a user to the betting scenario using the bet selection interface; and update the live video stream based on the response from the user.

According to some example embodiments, the live video stream is transmitted from a host user.

According to some example embodiments, the betting scenario is generated by the host user.

According to some example embodiments, the instructions further cause the processor to: retrieve a previous response to a previous bettering scenario by the user; generate a new betting scenario based on the previous response; send the new betting scenario to the user; and display the new betting scenario on the bet selection interface.

According to some example embodiments, the instructions further cause the processor to: retrieve a sporting event broadcast from a television service provider; display the sporting event broadcast on the live video stream; generate a new betting scenario from the sporting event broadcast; and display the new betting scenario on the bet selection interface.

According to some example embodiments, the instructions further cause the processor to: receive an additional live video stream from an additional user; and display the additional live video stream on the interface of the mobile device application.

According to some example embodiments, the instructions further cause the processor to display a graphic on the additional live video stream, wherein the graphic is based on an additional response to the betting scenario by the additional user.

According to some example embodiments, the instructions further cause the processor to display a ticker on the additional live video scream, wherein the ticker displays the additional response to the betting scenario.

According to some example embodiments of the present disclosure, in a method for operating a sports gaming event using a graphical interface of a mobile device application, the method includes: initiating, by a processor, a live video stream from a host user; sending, by the processor, an invite to view the live video stream to a user; receiving, by the processor, a response to the invite from the user; generating, by the processor, a betting scenario from the live video stream; sending, by the processor, the betting scenario to the user; receiving, by the processor, a response to the betting scenario from the user; and updating, by the processor, the live video stream based on the response from the user.

According to some example embodiments, the method further includes: inviting, by the processor, an additional user to view the live video stream; receiving, by the processor, an additional live video stream from the additional user; displaying, by the processor, the additional live video stream on the interface of the mobile device application; sending, by the processor, the betting scenario to the additional user; receiving, by the processor, an additional response to the betting scenario from the additional user; and updating, by the processor, the live video stream based on the additional response to the betting scenario.

According to some example embodiments of the present disclosure, in a system for operating a sports gaming event using a graphical interface of a mobile device application, the system includes: a processor; and a memory coupled to the processor, wherein the memory stores instructions that, when executed by the processor, cause the processor to: retrieve a live video stream of a sporting event broadcast from a television service provider; display the live video stream of the sporting event broadcast; send an invite to view the live video stream to a user; receive a response to the invite from the user; generate a betting scenario from the live video stream; send the betting scenario to the user; receive a response to the betting scenario from the user; and update the live video stream based on the response from the user.

### BRIEF DESCRIPTION OF THE DRAWINGS

FIG. 1 illustrates a system block diagram of the operation of the sports gaming mobile device application.

FIG. 2 illustrates an interface of the mobile device application according to an embodiment of the present disclosure.

FIG. 3 illustrates an interface of the mobile device application displaying a community call according to an embodiment of the present disclosure.

FIG. 4 illustrates an interface of the mobile device application displaying a visual overlay according to an embodiment of the present disclosure.

FIG. 5 illustrates an interface of the mobile device application that shows a leaderboard according to an embodiment of the present disclosure.

FIG. 6 illustrates an interface of the mobile device application that shows an individual user's betting history according to an embodiment of the present disclosure.

FIG. 7 illustrates an interface of the mobile device application showing a live sporting event according to another embodiment of the present disclosure.

FIG. 8 is a flowchart showing a method for operating a sports gaming event using a mobile device application, in accordance with example embodiments of the disclosure.

FIG. 9 is a flowchart showing a method for participating in a sports gaming event using a mobile device application, in accordance with example embodiments of the disclosure.

FIG. 10 is a flowchart showing a method for operating a sports gaming event using a mobile device application, in accordance with example embodiments of the disclosure.

### DETAILED DESCRIPTION

The exemplary embodiments of the present invention disclosed herein are directed to a system and method for the operation of a sports gaming event using a video integrated sports gaming mobile device application. As used herein, a sports gaming event refers to an event wherein at least one user places a wager on at least one betting scenario displayed within the application and wherein the outcome of the wager is maintained by the application. It will be appreciated that the term “sports” may refer to traditional sports such as soccer, baseball, and basketball, “esports” such as video games, as well as card games, board games, and any other competition on which betting scenarios could be generated.

In one example of a sports gaming event, a user of the application decides to place a wager on a particular betting scenario (described in more detail below) and the application updates and maintains such user's point or cash total after the betting scenario has occurred or has not occurred. In another example, a tournament in which multiple users place wagers on numerous betting scenarios based on a specified set of events (e.g., a specified game or a specified group of games) or based on a particular time frame (e.g., a single day, a single sports tournament, or a single season), wherein the point totals of each player are maintained for the duration of the specified set of events or time frame, and a winner is declared at the end of the tournament is also an example of a sports gaming event. However, it will be appreciated that there are countless other sports gaming events which involve at least one user placing a wager on at least one betting scenario that could be generated by, run on, and/or maintained by the application according to embodiments of the present invention.

In general, the mobile device application according to embodiments of the present invention allows for at least one live video feed to be displayed on an interface (e.g., a bet selection interface) wherein the application also allows users to place wagers via the interface as described in more detail below. As such, a user of the mobile device application will be able to simultaneously view the live video feed and participate in a sports gaming event, if they choose to, by placing wagers on the likelihood of an occurrence of an event displayed on the screen or by placing wagers selectable from a menu of betting scenario options. Alternatively, users of the application will be able to concurrently view the live video feed and also view the bets and betting patterns of other users participating in the sports gaming event even if they themselves are not placing any wagers.

In some embodiments, the mobile device application will allow for a plurality of video feeds to be displayed on an interface such that multiple users of the application will be able to see and communicate with each other within the mobile device application itself without having to run separate applications for the live video feed and the wagering capabilities. Such ability allows for the mobile device application to provide a convenient social experience for a user who can both participate in a live conversation with others connected to systems according to embodiments of the present invention and to participate in the sports gaming event by placing wagers within the same mobile device application. In addition, as described in more detail below, the mobile device application has the ability to automatically generate betting scenarios.

As used herein, a betting scenario refers to a particular outcome (e.g., a player will hit a homerun within the next three pitches) coupled with a price, i.e., a value that indicates the likelihood of such event occurring. For any betting scenario, a user will have the ability to place a wager on the event occurring and will obtain a reward in the form of real money, pretend money, points, or other scoring method, if the event occurs.

As described in more detail below, the application allows for a user to place wagers on the probability that specific events that may occur within the duration of a live sporting event rather than merely the final outcome and that the application can dynamically adjust the price of any betting scenario depending on various factors including actual occurrences in the live sporting event as well as the number and size of wagers placed on that particular betting scenario by other users. Further, the user can use information obtained from the live video feed to place wagers immediately after the betting scenario has been created. Further still, the application allows a user to create and display their own live betting scenarios for other users to wager on.

In some embodiments, the interface of the sports gaming mobile device application can include a live video stream adjacent to or otherwise being a part of a bet selection interface. The live video stream may be transmitted from at least one user (e.g., a host, host user, player/user), from multiple users, from a live broadcast feed of a sporting event, or from both users and a live broadcast feed. The bet selection interface can display one or more proposed betting scenarios for a live sporting event. As noted above, it will be appreciated that users of the application will be able to use information received from the live video stream to make decisions as to which betting scenarios on which to wager and to be able submit such wagers through the bet selection interface.

In some embodiments, a host can use the mobile device application to initiate a live video stream for operating a sports gaming event. The host can invite other users of the mobile device application (e.g., guests) to join and/or view the live video stream through the mobile device application. According to various embodiments, the sports gaming event can include a conference call (i.e., community call) among the host and the guests. The players on the community call can communicate with each other in real time and discuss, among other topics, current live sporting events and wagers placed by the other players on active or past betting scenarios related to such current live sporting events. Further, the players on the community call can praise or otherwise comment on the user who may be leading the sports gaming event, thereby adding to the social and competitive atmosphere of the community call.

Additionally, the application allows the host to be able to generate their own betting scenarios and the host can use information based on the communication with the other players on the community call to determine which betting scenarios to generate. The generated betting scenarios may appear on the bet selection interface of each player's device and allows each player to wager on such betting scenarios.

In some embodiments, a live feed of a sporting event can be streamed on the interface of the sports gaming mobile device application. The live feed of the sporting event will appear adjacent to or as otherwise a part of the bet selection interface. In some embodiments, betting scenarios corresponding to the live sporting event can be automatically generated by the application or by a user in real time and such generated betting scenarios can appear on the bet selection interface.

In some embodiments, the live feed of a sporting event can be incorporated into a community call allowing the players on the community call to be able to communicate with each other about the live sporting event while simultaneously viewing it together on their respective devices. In some embodiments, the host can generate betting scenarios based on the communication with the guests and the live sporting event feed. In other embodiments, betting scenarios corresponding to the live sporting event can be automatically generated in real time. The betting scenarios generated by the host and the automatically generated bets can be displayed on the bet selection interfaces of each guest's respective device.

In some embodiments, users can authenticate a television subscription in the mobile device application in order to view the live feed of a sporting event. In some embodiments, each player in a community call can authenticate their television subscription in the mobile device application. In some embodiments, different users in a community call can be aggregated together based on the timing of their respective broadcast feeds of the live sporting event.

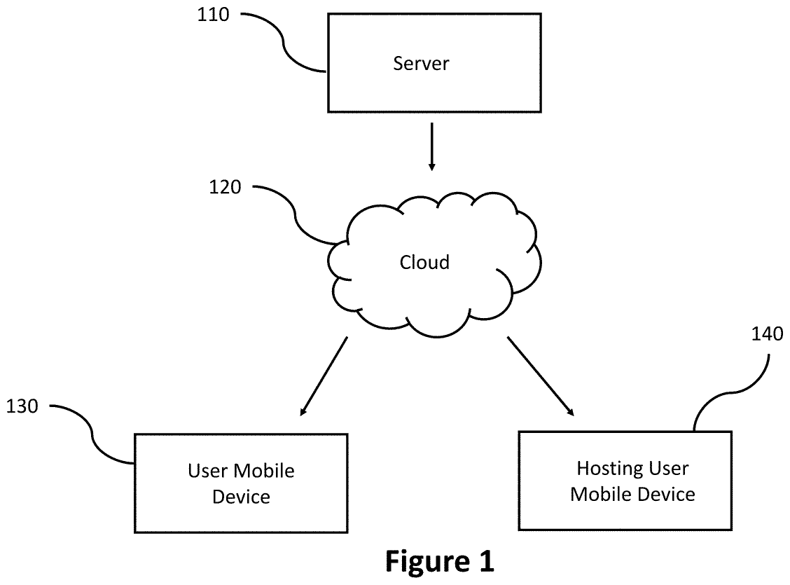

FIG. 1 illustrates a system block diagram of the operation of the sports gaming mobile device application.

Referring to FIG. 1, the server 110 can transmit data to and receive data from a computer network 120 such as the Internet. Further the computer network 120 can transmit data to and data from a user mobile device 130 and a hosting user mobile device 140. The user mobile device 130 can be a used by a user of the sports gaming mobile device application. The hosting user mobile device 140 can be used by a hosting user of the sports gaming mobile device application. In some embodiments, the server 110 can include a processor and memory storing instructions, where the processor executes the instructions to implement the gaming engine for managing the gaming event. While the terms “server,” “processor” and “memory” are used herein in the singular, embodiments of the present disclosure are not limited thereto, and may be implemented by multiple computer systems and/or computer servers, each of which may have one or more processors and one or more memories (e.g., different types of memory such as persistent memory and volatile memory). Therefore, unless otherwise explicitly described otherwise, operations that are described herein as being performed or implemented on a server and/or by a processor and memory may be construed as including being implemented on multiple servers and/or by multiple processors and memories, where the multiple servers may perform substantially the same tasks (e.g., operating in parallel), may perform substantially different tasks (e.g., perform different aspects of embodiments of the present disclosure), or combinations thereof.

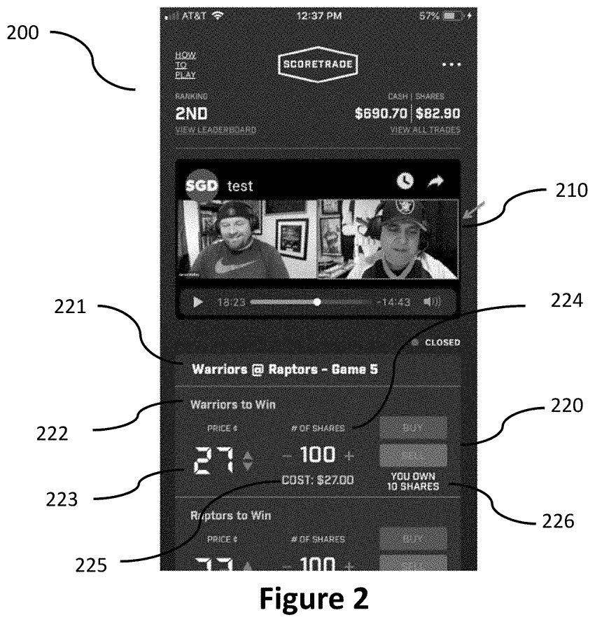

FIG. 2 illustrates an interface of the mobile device application according to an embodiment of the present disclosure.

According to FIG. 2, the mobile device application interface 200 can incorporate a video stream 210. In some embodiments, the video can be embedded into the mobile device application. In some embodiments, the video stream 210 may be integrated into the mobile device application using a video application programing interface (API) (e.g., Zoom). In some embodiments, the video may be integrated with a video calling engine that is capable of supporting large-scale user calls. The video stream 210 may be adjacent to or as otherwise a part of a bet selection interface 220. In some embodiments, video stream 210 may display a live video feed from at least one hosting user (e.g., a host) or a plurality of hosts. In other embodiments, the video stream 210 may also include a video broadcast feed of a live sporting event in addition to or as an alternative to the host live video feed. It will be appreciated that users can discuss a particular game or betting scenario on the live video stream and that the users can use the information received from the video stream 210 to place wagers on the betting scenarios using the bet selection interface 220. The bet selection interface 220 may display betting scenarios selected by the host or may display betting scenarios generated automatically by a gaming engine.

In some embodiments, the gaming engine may be run on a processing circuit (e.g., a processor) of a server. The gaming engine can receive sports data from third party data providers. The sports data may include real time updates or play-by-play information of live sporting events. For example, the data can be which team just scored, the current inning, the location of where the teams are playing, the current box score, the number of points scored by a player, which player just scored a point, and other sports data. The gaming engine can review the data as it is received and generate betting scenarios related to the received data. For example, the data may indicate that a football team has entered the Red Zone (e.g., the football team is within 20 yards of scoring a touchdown). The gaming engine can use this data to generate a bet on whether the quarterback will throw a touchdown pass, whether a particular wide receiver will catch the touchdown pass, or if the defense will prevent the offense from scoring a touchdown. Further, the gaming engine can determine the probability of whether the generated betting scenario will be successful. The probability can be updated in real time as the situation of the game changes. For example, if the quarterback in the Red Zone throws 2 incomplete passes and is in a third down situation, the gaming engine can adjust the probability of whether the quarterback will throw a touchdown pass. Additionally, the gaming engine can close the betting scenario (e.g., no longer accept wagers on that betting scenario) after the betting scenario has ended (e.g., the quarterback has already thrown the touchdown pass).

In some embodiments, the betting engine evaluates the volatility of a game situation, such how close is the score, how much time is remaining in the game, whether the game is in overtime, and the like, and generates proposed betting scenarios based on such volatility (e.g., proposition bets related to volatile aspects of the game situation). For example, in a tied basketball game at 100-100 with 5 minutes left, each bucket subsequently shifts the probability to favor the team that just scored and took the lead. If the lead changes happen often, the shifts are sudden, and only one outcome can be favorable ultimately.

In some embodiments, the gaming engine can generate betting propositions (or betting scenarios) that will likely happen within a close proximity of time (e.g., within minutes). For instance, the generated bet may be that a quarterback will complete 3 passes on this possession. This is a bet that will end within minutes, and may close within a single play if the quarterback throws an interception. Alternatively, the prop bet or betting scenario may last as long as it takes for the team to drive down the field and score a touchdown, field goal, or turn the ball over. Either way, the betting window may last a short time.

In some embodiments, the gaming engine may generate betting scenarios based on the profile of the user. For example, a user's profile may indicate that the user is a fan of a particular sporting team based on information provided by the user or based on the user's past betting history (e.g., bets frequently placed on particular players). The gaming engine can retrieve this information and automatically generate betting scenarios tailored to the user's favorite players or favorite teams.

In one embodiment, the bet selection interface 220 may include information about the betting scenario including the title of a sporting event 221, a bet description 222, and the price 223. For example, the price 223 may be a value of a single bet share, wherein the bet selection interface may also include the ability for a user to choose the total number of bet shares 224 that they would like to wager and which is also displayed by the bet selection interface. Further still, the bet selection interface can display the total cost 225 of the bet, the number of shares 226 of the betting scenario owned by the user, and buttons that allow a user to take certain actions, such as the ability to “Buy” or “Sell” a certain number of shares. It will be appreciated that the bet selection interface could also display other information associated with the betting scenario including, for example, the duration of a time limit placed on the betting scenario and the number of shares of that betting scenario held by other users.

The information displayed on the bet selection interface 220 can be updated in real time by the gaming engine due to the gaming engine processing certain information relating to a particular betting scenario and/or a particular sporting event. The gaming engine may track and cause to be displayed on the bet selection interface wagers placed by the players in the mobile device application. In some embodiments, the gaming engine may update the price 223 in response to recent events in a live sporting event or in response to bettors placing bets within the mobile device application. For example, the number of bets submitted for a particular bet or a team winning by a certain number of points may lead the gaming engine to adjust the price 223.

According to various embodiments, the host (e.g., host user) may be a user transmitting its live video stream 210 to a group of other users invited by the host (e.g., guests). In other embodiments, multiple users may serve as hosts of a scheduled gaming event or tournament. The mobile device application can use the embedded camera on the user's mobile device to record the video displayed on the video stream 200. Through the live video stream 210, the host may report on live sporting events and provide real time updates on gaming activities of other users and the users may use such information to decide whether to wager on particular betting scenarios. In addition, the host can share opinions or strategy on the betting scenario choices and sentiment can be used as an input to dynamically adjust live pricing and/or selection of the betting scenario choices. By way of example, the host may report which team has just scored, which player on the mobile device application profited the largest amount from a particular wager, or what type of bets are increasing in value. To this end, the host may have exclusive access to the other users' betting activities through an interface on the mobile device application. Alternatively, each user or a selected group of users may have access to other users' betting activities. In addition, the host can have access to a menu of betting scenarios that have been generated by the betting engine, by the host, or by another user. Using the menu of betting scenarios, the host can select various betting scenarios to be displayed on the bet selection interface 220 of each user.

In various embodiments, the host can launch its own video stream 210 and invite guests to join the stream. The video stream 210 may be structured as a conference video call (i.e., a community call) among the invited guests that allows the host and guests to communicate with each other, including communicating about current sporting events and wagers placed by the players on various betting scenarios. Through this ability to communicate directly with other users in real time, the host can organize gaming tournaments or fantasy leagues for the guests.

In some embodiments, the mobile device application can run the community call using its native video software. In other embodiments, the mobile device application may integrate a third party video call service provider (e.g., Zoom). According to this embodiment, the mobile device application can transmit each of the user's credentials to a the third party service provider, which will allows the camera on each of the user's mobile device to be used. In addition, each of the users can use the features of the third party service provider within the mobile device application.

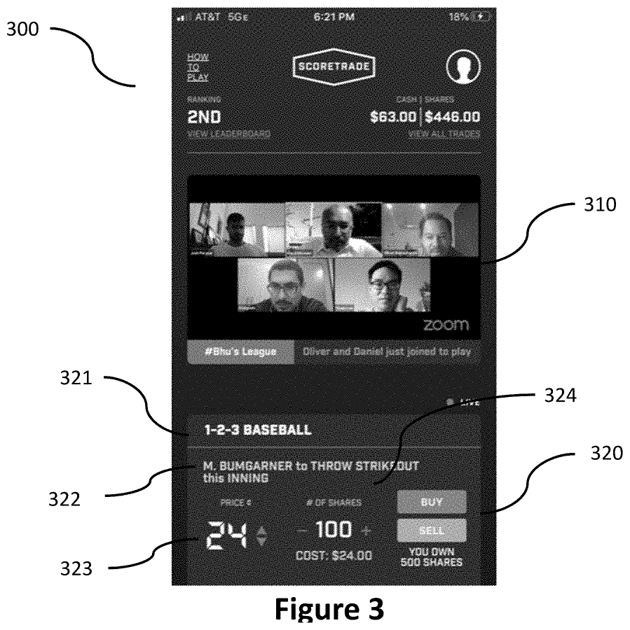

FIG. 3 illustrates an interface of the mobile device application displaying a community call according to an embodiment of the present disclosure.

Referring to FIG. 3, the mobile device application interface 300 can incorporate a video stream 310 adjacent to a bet selection interface 320. According to this embodiment, video stream 310 may display a collage of videos of one or more of the players in the community call. The host and guests can communicate with each other about current sporting events and bets placed by the players on the community call.

In one embodiment, the host can generate betting scenarios based on the conversation with the guests. For example, the host and guests may be arguing about whether a basketball player will continue his accurate shooting and the host can manually generate a betting scenario on whether the basketball player will score 50 points. The generated betting scenario can be displayed on the bet selection interface 320 of each of the guests.

Similar to the bet selection interface disclosed in FIG. 1 above, the bet selection interface 320 may include certain information relating to the displayed betting scenario including the title of a sporting event 321, a bet description 322, the price of a single bet share 323, and the total number of shares 324. The information displayed on the bet selection interface 320 can be updated in real time by the gaming engine. The gaming engine may track bets placed by the players in the mobile device application. In some embodiments, the gaming engine may update the price 323 in response to recent events in a live sporting event or in response to bettors placing bets within the mobile device application. For example, the gaming engine may generate a bet on whether a basketball team to win a current game. As the game progresses to its conclusion, the team may be increasing its lead. This may lead to the probability of whether the team will win the game. As such, the gaming engine can adjust the price 323 based on the changing probability of whether the bet will be successful.

According to some embodiments, the gaming engine can detect the geographic locations of the players on the community call using the embedded GPS software of the mobile devices and/or using geolocation based on other techniques such as the user's Internet Protocol (IP) address. The players may be in a geographic location where a known percent of users tend to be fans of a particular team. The gaming engine can use this information to generate bets tailored to this particular team.

According to some embodiments, the gaming engine can also review the profiles of the players on the community call. Particularly, the gaming engine may be programmed to be able to access each user's profile which may contain information relating to that user's preferences and interest in various sports, leagues, teams, and players and which may also contain information relating to that user's previous betting history within the app. Further, the user's profile may include the user's social media handles such as a Twitter account or Facebook profile. The gaming engine can review the social media account to identify the user's preferences.

Further, by reviewing a user's profile, the gaming engine can determine the user's enthusiasm for certain types of betting scenarios and the user's betting sophistication. The gaming engine's determination may be based on information provided by the user or otherwise accessible by the gaming engine, including the user's preferred college or university teams, favorite professional sports teams, favorite professional players, prior betting histories, or other factors. For example, the gaming engine can review the user's betting history and detect that a particular user does not respond well to particular types of offered bets. The gaming engine can then generate a different bet consistent with the bets that the user tends to favor. Using this information, the gaming engine can identify matching interests in multiple profiles and generate betting scenarios or fantasy contests relating to the matching interests. In some embodiments, the gaming engine determines whether a user will respond well to a particular offered bets based on a trained statistical model or machine learning model such as a regression model, a support vector machine, or a neural network. For example, the gaming engine can detect the correlation between several factors, such as who is the user's friend, where the user is based, and what bets does the user respond to. The automatically generated betting scenarios can appear on the bet selection interface 320.

In some embodiments, the host or a guest may also be able to select graphical elements to be displayed under a particular player's video on the video stream 310 for a certain period of time. The graphical elements, for example, a visual image of virtual fireworks, a “thought bubble,” an emoji, among many others, may be indicative of the bet placed by that player. The graphical elements may or may not include text accompanying and/or explaining the graphical element. In some embodiments, the graphical elements can be sent via the API to a third-party video hosting software to generate graphical elements. In this case, the graphic elements can be placed within the video elements before the client gaming application shows the images within the video stream 310. The graphical elements can be displayed on user's interface, where the graphical elements are not a part of the video stream, but can be generated by the user to be placed over the relevant user when they appear on the video stream 310. In some embodiments, a speech-to-text system can be used to determine which of the users may be speaking during the community call. The gaming engine can generate data related to a particular bet to be placed visually next to a video of the user discussing the particular bet. According to some embodiments, a speech to text system may be used to help generate bets. The conversation on the community call can be converted to text in real time using a voice to text system. The text can be reviewed by the gaming engine to generate bets tailored to the conversation. By way of example, the players on the community call may be arguing over whether a basketball player can maintain his accurate shooting percentage and score 50 points. In some embodiments, the gaming engine can parse the text of the conversation and detect keywords such as “bet”, “score”, “points”. The gaming engine can then match the parsed text to stored templates such as “I bet [player name] will score [number] points by [specific time in the game]”. The gaming engine can automatically generate a bet based on the parsed values (shown in brackets) from the matching template. In some embodiments, the gaming engine could use the text as a data input. For example, the gaming engine can detect a basketball player's name in the text. Based on the detection of the basketball player's name, the gaming engine can generate bets related to the basketball player (e.g., the basketball player will score 50 points in the current game). In some embodiments, a human gaming operator overseeing the operation of the mobile device application may also review the text and content of the conversation. The human gaming operator can see the argument and generate a bet based on the argument (e.g., a bet that the basketball player will score 50 points). The bet generated by the human gaming operator can appear on the bet selection interface 320.

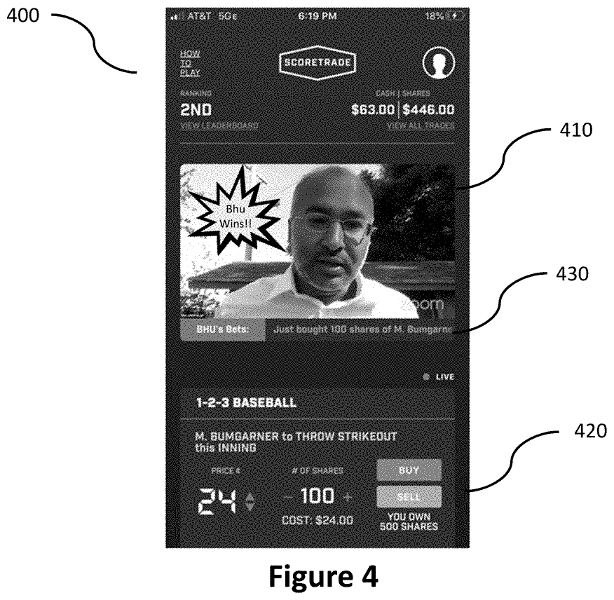

In some embodiments, the gaming engine can generate visual overlays and data elements to display with the videos of the players shown on the video stream 310. By way of example, if a player is talking and the video stream 310 is showing the player's face, the betting activity of the player can be displayed underneath the player's face or underneath the video stream (see also FIG. 4). Additionally, the overlays may show aggregate data, the player's current standing within a tournament of multiple players, how the player's current bets are performing, or other player information. In some embodiments, the data elements may be displayed as a ticker. This can allow the other players to review the player's betting activities, especially if that player is not actively participating or speaking on the community call.

FIG. 4 illustrates an interface of the mobile device application displaying a visual overlay according to an embodiment of the present disclosure.

Referring to FIG. 4, the mobile device application interface 400 can incorporate a video stream 310 adjacent to a bet selection interface 420. According to this embodiment, a bet ticker 430 can be displayed under the video stream 410. The bet ticker 430 can display the recent gaming activity of the player on the video stream 410, and can be viewed by the other players on the community call. For example, the player may have recently bought 100 shares of a football team to win on Sunday. The bet ticker 430 would inform the other players of this bet in real time.

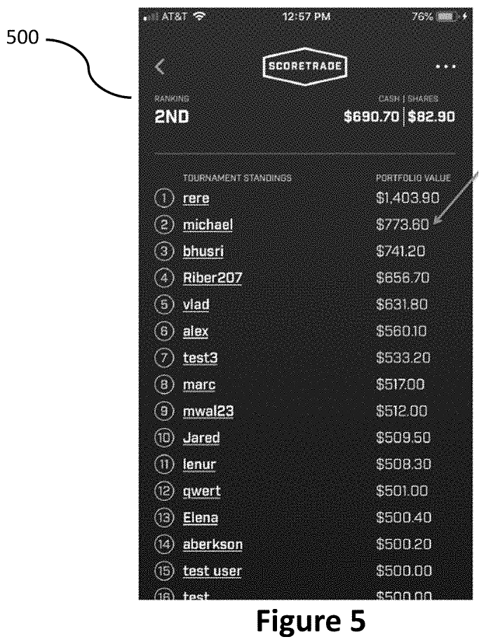

FIG. 5 illustrates an interface of the mobile device application that shows a leaderboard according to an embodiment of the present disclosure.

Referring to FIG. 5, the interface of the mobile device application 500 can include a ranking of the users according to the users' portfolio values (e.g., leaderboard). The portfolio values may include real money, fake money, and/or non-monetary units or points. In some embodiments, the leaderboard may only be accessed by the host. The host can report which users are on the leaderboard, their portfolio values, and real time changes to the leaderboard to the other users through the live video stream. For example, the host can report that a user has moved from 10th place to 2nd place due to the user winning an improbable betting scenario. Other users can use this information from the host to influence their betting decisions.

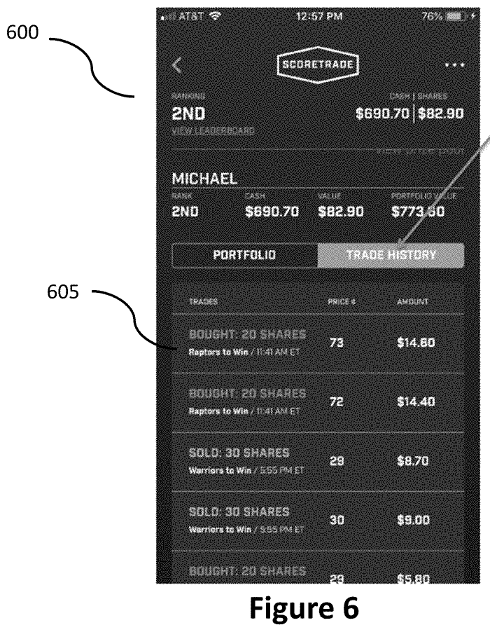

FIG. 6 illustrates an interface of the mobile device application that shows an individual user's betting history according to an embodiment of the present disclosure.

Referring to FIG. 6, the interface of the mobile device application 600 can display an individual user's portfolio and trade history in real time. In some embodiments, the individual user's trade history may only be accessed by the host. The mobile device application interface 600 may include a list of each individual bet 605 made by the selected user or only some of the bets made by that user. The host can review the list and comment on the user's trades to other users through the live video stream. For example, the host can report that a user recently bought 20 shares for a sports team to win a game that evening. Other users can use this information from the host to make their betting decisions.

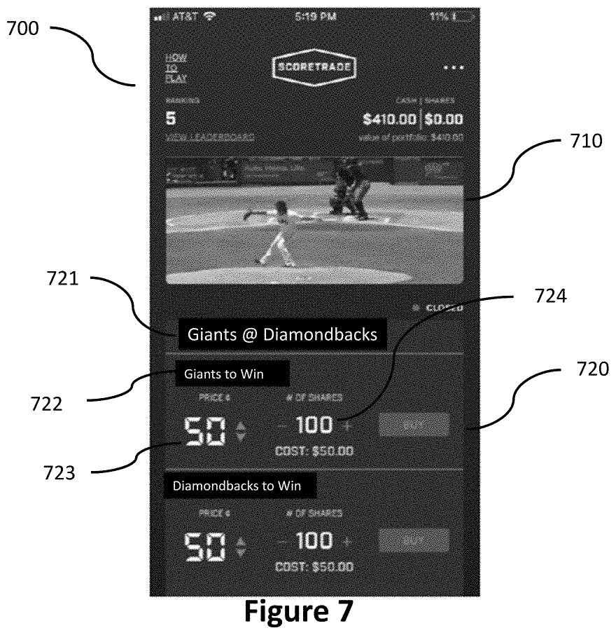

FIG. 7. illustrated an interface of the mobile device application showing a live sporting event according to another embodiment of the present disclosure.

Referring to FIG. 7, the mobile device application interface 700 can incorporate a video stream 710 adjacent to or as otherwise a part of a bet selection interface 720. According to this embodiment, video stream 710 may display a live video broadcast feed from a sporting event. In some embodiments, the bet selection interface 720 can display betting scenarios based on the sporting event being shown on the video stream 710. For example, the video stream 710 may show a baseball game and the bet selection interface 720 can display a proposed bet on whether the pitcher will strike out the next batter. Further, the betting engine may be capable of transcribing audio of the video stream 710 or accessing the closed caption text of the video stream and based on such information, the betting engine may be able to automatically generate betting scenarios to be offered to users of the application.

Similar to the bet selection interfaces disclosed in FIGS. 2, 3, and 4 above, the bet selection interface 720 may include information about various betting scenarios, including among other things the title of a sporting event 721, a bet description 722, the price of a single share of the bet 723, and the total number of shares 724. The information displayed on the bet selection interface 720 can be updated in real time by the gaming engine. The gaming engine may track bets placed by the players in the mobile device application. In some embodiments, the gamine engine may update the price 723 in response to recent events in a live sporting event or in response to bettors placing bets within the mobile device application. For example, the number of bets submitted for a particular bet or a team winning by a certain amount of points may lead the gaming engine to adjust the price 723.

In order to view a live sporting event on the video stream 710, the user may be required to have a television provider subscription, such as a cable television subscription or a satellite television subscription. Many common television subscription services provide a username and password to subscribers. The mobile device application can allow users to authenticate their subscriptions by allowing them to enter the username and passwords corresponding to their television subscription. The mobile device application can verify the username and password information with the corresponding subscription provider. If verification is successful, the mobile device application can retrieve the broadcast feed of the live sporting event and display it on the video stream 710.

In some embodiments, the live sporting event on the video stream 710 can be integrated into a community call. The host and guests can communicate with each other about the live sporting event on the video stream 710. The host can generate bets based on the conversation with the guests and based on the live sporting event. In some embodiments, the gaming engine can use sentiment analysis of the community call to assist in generating bets and adjust the pricing of the bets. The generated bet can be displayed on the bet selection interface 720 for each of the guests. Each guest may also be required to have a television provider subscription in order to view the live sporting event on the video stream 710. The mobile device application can allow the guests to authenticate their subscriptions by allowing them to enter the username and passwords corresponding to their television subscriptions. The mobile device application can verify the username and password information with the corresponding subscription provider. In one embodiment, the system could check to see if the mobile user is an authenticated subscriber either on a monthly, trial, or pay-per-view or other basis before showing the live stream of the game. Additionally, if the mobile user is a paid and authenticated subscriber, the system could also offer a co-stream or community stream, which can now incorporate footage from the live event because the user is authenticated.

In some embodiments, the system could also show a limited portion of the game with a prompt that the mobile user should become a subscriber to a pay TV package, a direct subscription to a digital package carrying the event, or a pay-per-view type of payment to continue to watch the event.

In another embodiment, the application could mandate a user-requirement that to qualify for prizes the mobile user must be authenticated. Additionally, the system could be configured to offer bigger prizes to authenticated users as opposed to unauthenticated users. Additionally, unauthenticated users could play to win trial subscriptions or discounted subscriptions to various pay TV bundles or pay per view credits, wherein the prize pool itself is used as a user acquisition tool for pay TV subscriptions.

In one embodiment, the system authenticates a user by syncing the user's password with the pay tv system, via IP address, or other validation system agreed upon between the pay TV, sports rightsholder, subscription TV provider, or other layer. Once a user has been authenticated for a single session, multiple sessions, or for the period of their subscription or pay per view period, the system could access and show any, some or all of the sports that the user is entitled to watch through their subscription.

Additionally, if the user has been authenticated via the mobile in-game sports gaming and wagering application, the system could recognize that the user has access to other screens such as large screen televisions where a particular game may be watched—in this case, the user's television could be enabled to show data from the in-game mobile application transposed onto the TV screen.

In an ATSC 3.0 environment or other TV data format, the ability to personalize the data transposed on sports broadcasts to enhance a mobile experience and vice versa, use the mobile experience to enhance a broadcast is possible and in-game wagering data from an authenticated mobile user's gaming application can be transposed onto that particular's user's television or another device.

In one embodiment, the system allows authentication for broadcast television streams that require some form of retransmission consent in order to be streamed into a mobile application.

In some situations, the live sporting event feed may be slightly delayed for some users on the community call. For example, one player's feed may be one minute behind the video feeds of the other players. This delay could create an unfair advantage for players with an earlier feed because they can place bets based on information the other users do not have. The differences in the timing of the feed may be due to the differences in the users' television subscription service providers. For example, the timing of the cable service provider feed may be different from the timing of the satellite service provider feed. In some embodiments, the gaming engine can push players to a call or tournament that aggregates players watching the same live sporting event on a similar delay (e.g., guests who are subscribed to service providers that have the same or similar delays). In some embodiments of the present disclosure, players having similar delay are detected based on correlations of timestamps of their inputs to the mobile application, such as the timing of their responses to prop bets. In other embodiments, the engine may only generate bets that do not have a significant time advantage.

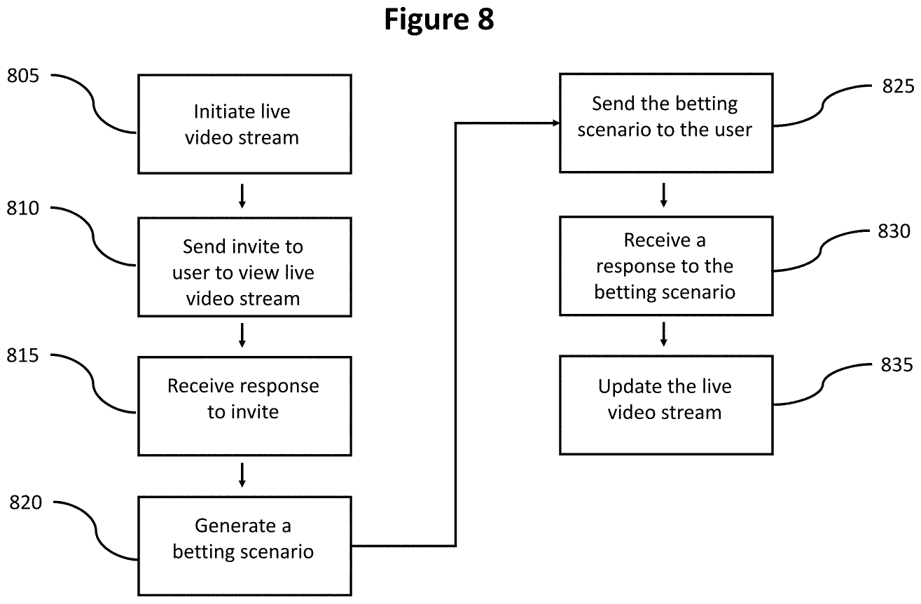

FIG. 8 is a flowchart showing a method for operating a sports gaming event using a mobile device application, in accordance with example embodiments of the disclosure. According to some example embodiments, the number and order of operations illustrated in FIG. 8 may vary. For example, according to some example embodiments, there may be fewer or additional operations, unless otherwise stated or implied to the contrary. Additionally, the order of the operations may vary, unless otherwise stated or implied to the contrary. In some embodiments, the operations illustrated in FIG. 8 may be implemented using a processor and a memory coupled to the processor, where the memory has instructions that that cause the processor to implement the operations.

Referring to FIG. 8, the a live video stream can be initiated on the mobile device application in 805. In some embodiments, the live video stream can be initiated by a host user. In 810, an invite can be sent to another user that invites the user to view the live video stream. The user can receive the invite and send a response to the invite in 815. In 820, a betting scenario (e.g., a bet) can be generated from the live video stream. In some embodiments, the betting scenario can be generated by the host user. In some embodiments, the betting scenario can be generated automatically, as discussed above. The betting scenario can be sent to the user in 825. In some embodiments, the generated bet can be displayed on a bet selection interface. In 830, the user can send a response to the betting scenario using the bet selection interface. In 835, the live stream can be updated based on the user's response to the betting scenario.

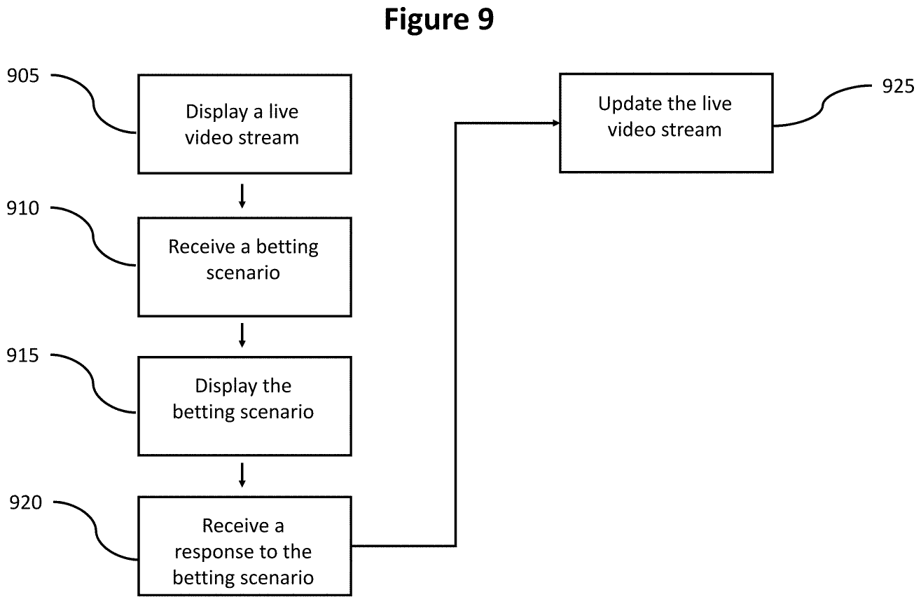

FIG. 9 is a flowchart showing a method for participating in a sports gaming event using a mobile device application, in accordance with example embodiments of the disclosure. According to some example embodiments, the number and order of operations illustrated in FIG. 9 may vary. For example, according to some example embodiments, there may be fewer or additional operations, unless otherwise stated or implied to the contrary. Additionally, the order of the operations may vary, unless otherwise stated or implied to the contrary. In some embodiments, the operations illustrated in FIG. 9 may be implemented using a processor and a memory coupled to the processor, where the memory has instructions that that cause the processor to implement the operations.

Referring to FIG. 9, a live video stream can be displayed on the mobile device application interface in 905. In some embodiments, the live video stream can be a transmitted from a host user. In some embodiments, the live video stream can be a live sporting event broadcast feed from a television service provider (e.g., a cable TV provider or a satellite TV provider). In 910, a betting scenario can be received. In some embodiments the betting scenario can be generated by a host user. In some embodiments, the betting scenario can be generated automatically, as discussed above. The betting scenario can be displayed in 915. In some embodiments, the betting scenario can be displayed on a betting selection interface. In 920, the user can send a response to the betting scenario using the bet selection interface. In 925, the live stream can be updated based on the user's response to the betting scenario.

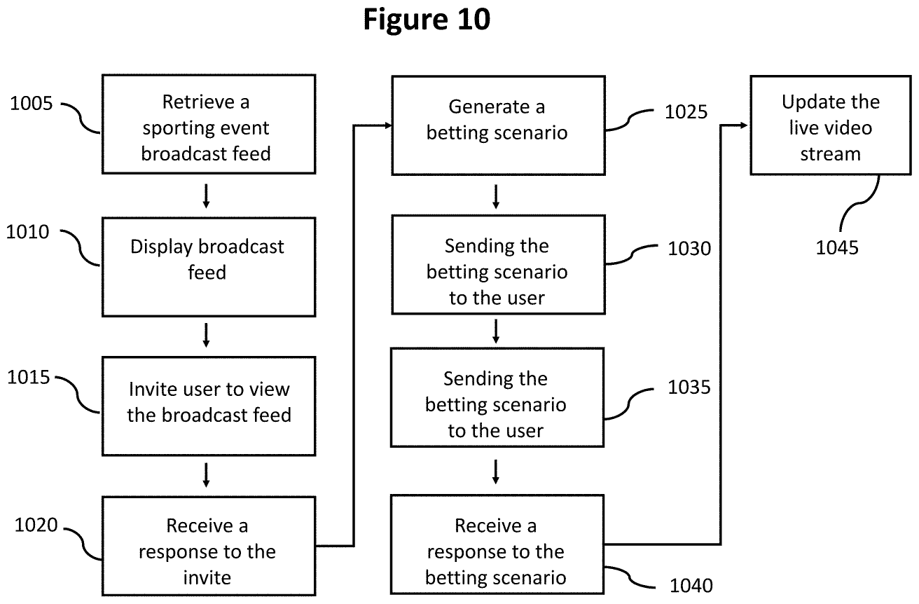

FIG. 10 is a flowchart showing a method for operating a sports gaming event using a mobile device application, in accordance with example embodiments of the disclosure. According to some example embodiments, the number and order of operations illustrated in FIG. 10 may vary. For example, according to some example embodiments, there may be fewer or additional operations, unless otherwise stated or implied to the contrary. Additionally, the order of the operations may vary, unless otherwise stated or implied to the contrary. In some embodiments, the operations illustrated in FIG. 10 may be implemented using a processor and a memory coupled to the processor, where the memory has instructions that that cause the processor to implement the operations.

Referring to FIG. 10, a live sporting event broadcast feed can be retrieved from a television service provider in 1005. The live sporting event broadcast feed can be displayed as a live video stream on the mobile device application in 1010. In 1015, an invite can be sent to another user that invites the user to the sporting event broadcast. The user can receive the invite and send a response to the invite in 1020. In 1025, a betting scenario (e.g., a bet) can be generated from the live video stream. In some embodiments, the betting scenario can be generated automatically, as discussed above. The betting scenario can be sent to the user in 1030. In some embodiments, the generated bet can be displayed on a bet selection interface. In 1040, the user can send a response to the betting scenario using the bet selection interface. In 1045, the live stream can be updated based on the user's response to the betting scenario.

It will be understood that when an element is referred to as being “on,” “connected to,” or “coupled to” another element, it may be connected, or coupled to the other element or one or more intervening elements may also be present. When an element is referred to as being “directly connected to,” or “directly coupled to” another element, there are no intervening elements or layers present. For example, when a first element is described as being “coupled” or “connected” to a second element, the first element may be directly coupled or connected to the second element or the first element may be indirectly coupled or connected to the second element via one or more intervening elements.

The same reference numerals designate the same elements. As used herein, the term “and/or” includes any and all combinations of one or more of the associated listed items. Further, the use of “may” when describing embodiments of the present invention relates to “one or more embodiments of the present invention.” Expressions, such as “at least one of,” when preceding a list of elements, modify the entire list of elements and do not modify the individual elements of the list. Also, the term “exemplary” is intended to refer to an example or illustration. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments. In the figures, dimensions of the various elements, layers, etc. may be exaggerated for clarity of illustration.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing particular example embodiments of the present invention and is not intended to be limiting of the described example embodiments of the present invention. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a) and 35 U.S.C. § 132(a).

The term “processing circuit” is used herein to mean any combination of hardware, firmware, and software, employed to process data or digital signals. Processing circuit hardware may include, for example, radio baseband processors (BPs or BBPs), application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Various computational portions of embodiments of the present invention, including the operation of a sports gaming event through a mobile device application, may be implemented through purpose-specific computer instructions executed by a computer system. The computer system may include one or more processors, including one or more central processing units (CPUs), one or more graphics processing units (GPUs), one or more field programmable gate arrays (FPGAs), one or more digital signal processors (DSPs), and/or one or more application specific integrated circuits (ASICs). The computer system may also include peripherals such as communications devices (e.g., network adapters, serial or parallel data bus adapters, graphics adapters) for transmitting and/or receiving data to and from other devices such as data storage systems (e.g., databases), display devices, and other computer systems. The computations may be distributed across multiple separate computer systems, some of which may be local to the users (e.g., user devices such as smartphones and personal computers) and some of which may be remote (e.g., off-site, “cloud” based computing resources connected to the user devices through a wide area network such as the Internet).

Although example embodiments of the video integrated sports gaming mobile device application system have been described and illustrated herein, many modifications and variations within those embodiments will be apparent to those skilled in the art. Accordingly, it is to be understood that the video integrated sports gaming mobile device application according to the present invention may be embodied in forms other than as described herein without departing from the spirit and scope of the present invention. The present invention is defined by the following claims and equivalents thereof.

What is claimed is:

1. A system for operating a sports gaming event using a graphical interface of a mobile device application, the system comprising:
a processor; and
a memory coupled to the processor, wherein the memory stores instructions that, when executed by the processor, cause the processor to:
initiate a live video stream from a host user;
send an invite to view the live video stream to a user;
receive a response to the invite from the user;
generate a betting scenario from the live video stream;
send the betting scenario to the user;
receive a response to the betting scenario from the user; and
update the live video stream based on the response from the user.

2. The system according to claim 1, wherein the instructions further cause the processor to:
invite an additional user to view the live video stream;
receive an additional live video stream from the additional user;
display the additional live video stream on the interface of the mobile device application;
send the betting scenario to the additional user;
receive an additional response to the betting scenario from the additional user; and
update the live video stream based on the additional response to the betting scenario.

3. The system according to claim 2, wherein the instructions further cause the processor to display a graphic on the additional live video stream, wherein the graphic is based on the additional response to the betting scenario.

4. The system according to claim 2, wherein the instructions further cause the processor to display a ticker on the additional live video scream, wherein the ticker displays the additional response to the betting scenario.

5. The system according to claim 1, wherein the betting scenario is generated by the host user.

6. The system according to claim 1, wherein the instructions further cause the processor to:
retrieve a previous response to a previous betting scenario by the user;
generate a new betting scenario based on the previous response; and
send the new betting scenario to the user.

7. The system according to claim 1, wherein the instructions further cause the processor to display a leaderboard.

8. The system according to claim 1, wherein the instructions further cause the processor to display a list of previous responses to previous betting scenarios by the user.

9. The system according to claim 1, wherein the instructions further cause the processor to:
initiate a gaming tournament;
invite the user to participate in the gaming tournament;
generate a plurality of betting scenarios for the gaming tournament;
send the plurality of betting scenarios to the user; and
receive responses to the plurality of betting scenarios from the user.

10. A system for participating in a sports gaming event using a graphical interface of a mobile device application, the system comprising:
a processor; and
a memory coupled to the processor, wherein the memory stores instructions that, when executed by the processor, cause the processor to:
display a live video stream;
receive a betting scenario generated from the live video stream;
display the betting scenario on a bet selection interface; and
receive a response from a user to the betting scenario using the bet selection interface; and
update the live video stream based on the response from the user.

11. The system according to claim 10, wherein the live video stream is transmitted from a host user.

12. The system according to claim 11, wherein the betting scenario is generated by the host user.

13. The system according to claim 10, wherein the instructions further cause the processor to:
retrieve a previous response to a previous bettering scenario by the user;
generate a new betting scenario based on the previous response;
send the new betting scenario to the user; and
display the new betting scenario on the bet selection interface.

14. The system according to claim 10, wherein the instructions further cause the processor to:
retrieve a sporting event broadcast from a television service provider;
display the sporting event broadcast on the live video stream;
generate a new betting scenario from the sporting event broadcast; and
display the new betting scenario on the bet selection interface.

15. The system according to claim 10, wherein the instructions further cause the processor to:
receive an additional live video stream from an additional user; and
display the additional live video stream on the interface of the mobile device application.

16. The system according to claim 15, wherein the instructions further cause the processor to display a graphic on the additional live video stream, wherein the graphic is based on an additional response to the betting scenario by the additional user.

17. The system according to claim 16, wherein the instructions further cause the processor to display a ticker on the additional live video scream, wherein the ticker displays the additional response to the betting scenario.

18. A method for operating a sports gaming event using a graphical interface of a mobile device application, the method comprising:
initiating, by a processor, a live video stream from a host user;
sending, by the processor, an invite to view the live video stream to a user;
receiving, by the processor, a response to the invite from the user;
generating, by the processor, a betting scenario from the live video stream;
sending, by the processor, the betting scenario to the user;
receiving, by the processor, a response to the betting scenario from the user; and
updating, by the processor, the live video stream based on the response from the user.

19. The method according to claim 18, the method further comprising:
inviting, by the processor, an additional user to view the live video stream;
receiving, by the processor, an additional live video stream from the additional user;
displaying, by the processor, the additional live video stream on the interface of the mobile device application;
sending, by the processor, the betting scenario to the additional user;
receiving, by the processor, an additional response to the betting scenario from the additional user; and
updating, by the processor, the live video stream based on the additional response to the betting scenario.

20. A system for operating a sports gaming event using a graphical interface of a mobile device application, the system comprising:
a processor; and
a memory coupled to the processor, wherein the memory stores instructions that, when executed by the processor, cause the processor to:
retrieve a live video stream of a sporting event broadcast from a television service provider;
display the live video stream of the sporting event broadcast;
send an invite to view the live video stream to a user;
receive a response to the invite from the user;
generate a betting scenario from the live video stream;
send the betting scenario to the user;
receive a response to the betting scenario from the user; and
update the live video stream based on the response from the user.
